(19) United States
(12) Patent Application Publication
(10) Pub. No.: US 2017/0287056 A1
(43) Pub. Date: Oct. 5, 2017

(54) SYSTEMS AND METHODS FOR ACQUIRING AN ARTICLE OF CLOTHING WORN BY A CELEBRITY FEATURED IN A MEDIA ASSET

(71) Applicant: Rovi Guides, Inc., San Carlos, CA (US)

(72) Inventor: Jennifer Lynn Dohlman, Tulsa, OK (US)

(21) Appl. No.: 15/084,777

(22) Filed: Mar. 30, 2016

(51) Int. Cl. G06Q 30/06; G06K 9/62; G06F 17/30; G06T 7/00

(52) U.S. Cl. CPC G06Q 30/0639; G06Q 30/0623; G06T 7/0002; G06K 9/6202; G06F 17/30256; G06T 2207/30124

(57) ABSTRACT

Systems and methods for acquiring an article of clothing worn by a celebrity featured in a media asset. The media asset featuring the celebrity is received from a media source. A frame is identified in the media asset that includes the article of clothing worn by the celebrity. An identifier is determined for the article of clothing in the identified frame. If the user is determined to be in possession of the article of clothing, an instruction is transmitted requesting the location for the article of clothing based on the identifier. The location is generated for display to the user based on a response to the instruction. If the user is determined to not be in possession of the article of clothing, a location is determined for acquiring the article of clothing. The location to acquire the article of clothing is generated for display to the user.

### BACKGROUND

Fashion and television have gone hand in hand since the days of black and white programming. With millions of people watching television programs everyday, television has become one of the most influential visual mediums in fashion. Some television programs, such as “America's Next Top Model” and “Project Runway,” take this premise and incorporate fashion as the hook to gain more viewers. Other television programs, such as “Mad Me ” and “Gossip Girl,” drive fashion trends for their viewers even without explicitly calling to attention what the television characters are wearing. Typical television systems do not inform the viewers on details of the fashion trends being incorporated into television programs. However, it would be in the interest of television viewers, if television systems assisted the viewer in discovering more about the fashion trends featured in their favorite television programs.

### SUMMARY

Sometimes while watching a television program featuring a celebrity wearing a particular article of clothing, such as a scarf, may pique a viewer's interest in the article of clothing. The viewer may be interested in learning more about the article of clothing. Particularly, the viewer may be interested in acquiring the article of clothing for his or her wardrobe. Or the viewer may benefit from being reminded that the particular article of clothing the viewer is interested in is already present in his or her wardrobe. The systems and methods provided herein provide for an interactive media guidance application to assist a viewer in acquiring an article of clothing worn by a celebrity featured in a media asset. The interactive media guidance application may be implemented in one or more of a television set-top box, a mobile phone, a tablet computer, or another suitable device.

When the viewer or user of the interactive media guidance application expresses an interest in an article of clothing worn by a celebrity featured in the current media asset, the interactive media guidance application determines an identifier for the article of clothing to assist the user in acquiring the article of clothing. The interactive media guidance application may receive metadata from a media source providing the media asset. The metadata indicates identifiers for one or more articles of clothing featured in the media asset. For example, the metadata may indicate identifiers for each article of clothing in a particular frame of the media asset. The identifier may be a bar code, a serial number, an image of the article of clothing, or any other suitable identifier for uniquely identifying the article of clothing.

Alternatively or additionally, the interactive media guidance application receives a user selection of a frame in the media asset. For example, the user may pause the media asset at the particular frame. The user may select an article of clothing featured in the frame using a user input device. The interactive media guidance application may retrieve an identifier for the selected article of clothing from metadata associated with the media asset. Alternatively or additionally, the interactive media guidance application may apply an image recognition algorithm to the particular frame to recognize the selected article of clothing. The interactive media guidance application may transmit the results of the image recognition algorithm to a clothing database and request an identifier for the article of clothing from the clothing database.

The interactive media guidance application determines whether the user is in possession of the identified article of clothing. For example, the identified article of clothing may be present in a closet, a storage space, a particular room, or any other suitable space where the user may have stored the article of clothing in his or her possession. The interactive media guidance application may transmit the identifier to a user database and request whether the user database includes the article of clothing associated with the identifier. If the interactive media guidance application receives a response indicating the article of clothing is present in the user database, the interactive media guidance application informs the user accordingly. The interactive media guidance application may provide the user an option to retrieve additional information from the user database regarding the article of clothing in his or her possession. The user database may be stored locally in the same memory as the interactive media guidance application or in another memory remote from the interactive media guidance application.

The user database stores identifiers and any other additional information for articles of clothing in the user's possession. The user database may receive information for updating the articles of clothing in the user's possession in the form of a bar code, a serial number, an image of the article of clothing, a retailer name, a style or clothing line, a size, or any other suitable information for identifying the article of clothing. The user database may help identify which articles of clothing being worn by the celebrity featured in a media asset are in the user's possession and assist the user in achieving the same or similar look. The user database may also assist in identifying which articles of clothing are not in the user's possession and need to be acquired for the user to complete the same or similar look as the celebrity featured in the media asset.

When the interactive media guidance application determines that the user is not in possession of the article of clothing worn by the celebrity featured in the media asset, the interactive media guidance application determines a location for the user to acquire the article of clothing. The interactive media guidance application may determine the location based on the user's preferences, such as preferred retailers, the user's location, the user's budget, or any other suitable preferences. Alternatively or additionally, the interactive media guidance application provides the user access to one or more online retailer websites for acquiring the article of clothing. The interactive media guidance application may optionally broaden the parameters specified in the user's preferences if too few or no locations for the user to acquire the article of clothing are found.

In some embodiments, the interactive media guidance application determines one or more articles of clothing similar to the article of clothing worn by the celebrity featured in the media asset. The interactive media guidance application determines the similar articles of clothing based on the retailer, the size, the style, or another suitable feature of the article of clothing worn by the celebrity featured in the media asset. The interactive media guidance application may determine a location for the user to acquire the similar article of clothing based on the user's preferences, such as preferred retailers, the user's location, the user's budget, or any other suitable preferences. The interactive media guidance application may optionally broaden the parameters specified in the user's preferences if too few or no locations for the user to acquire the similar article of clothing are found.

In some embodiments, information regarding the articles of clothing worn by a celebrity featured in a media asset are provided by one or more of the content provider, the service provider, the retailer for each article of clothing, or another suitable third party. The service provider may generate revenue from sales of the article of clothing and/or advertising the articles of clothing for the respective retailers. The service provider may use the ability for the viewer to purchase featured articles of clothing as a selling feature for their service. The service provider may contract with retailers to include television programs in their schedule that feature articles of clothing sold by the retailers.

In some embodiments, information regarding the articles of clothing worn by a celebrity featured in a media asset are specified by the content provider, the service provider, the retailer for each article of clothing, or another suitable third party. In some embodiments, information regarding the articles of clothing worn by a celebrity featured in a media asset is manually input by one or more users of the interactive media guidance application. In some embodiments, information regarding the articles of clothing worn by a celebrity featured in a media asset is automatically determined based on image recognition of the articles of clothing via image recognition algorithms. In some embodiments, errors in information regarding the articles of clothing worn by a celebrity featured in a media asset are corrected via user feedback. If the user finds the information to be erroneous, the user can input a correction via the interactive media guidance application. The interactive media guidance application may update the information depending on the likelihood of the user's feedback being helpful. This may avoid situations where the user has intentionally or carelessly input incorrect updates for the information. For example, if a number of users input the same correction for the information, the interactive media guidance application may update the information. In another example, if the user providing the correction has a high reputation score, the interactive media guidance application may update the information.

In some aspects, the systems and methods described herein provide for a method for acquiring an article of clothing worn by a celebrity featured in a media asset. The method may be implemented in an interactive media guidance application running on control circuitry of a user equipment device, such as a television set-top box. The interactive media guidance application receives, from a media source, the media asset featuring the celebrity. The interactive media guidance application identifies a frame in the media asset that includes the article of clothing worn by the celebrity. The interactive media guidance application determines an identifier for the article of clothing in the identified frame. The interactive media guidance application determines whether a user viewing the media asset is in possession of the article of clothing based on the identifier. For example, the viewer may be interested in learning more about the article of clothing. Particularly, the viewer may be interested in acquiring the article of clothing for his or her wardrobe. Or the viewer may benefit from being reminded that the particular article of clothing the viewer is interested in is already present in his or her wardrobe.

In response to determining that the user is not in possession of the article of clothing, the interactive media guidance application determines a location for acquiring the article of clothing and generates for display the location for the user to acquire the article of clothing. For example, the interactive media guidance application may determine the location based on the user's preferences, such as preferred retailers, the user's location, the user's budget, or any other suitable preferences. Alternatively or additionally, the interactive media guidance application provides the user access to one or more online retailer websites for acquiring the article of clothing. The interactive media guidance application may optionally broaden the parameters specified in the user's preferences if too few or no locations for the user to acquire the article of clothing are found.

In some embodiments, the interactive media guidance application identifies the frame in the media asset that includes the article of clothing worn by the celebrity by receiving, from a user input device, a first selection identifying the frame in the media asset and a second selection identifying the article of clothing worn by the celebrity included in the frame. For example, the interactive media guidance application receives a user selection of a frame in the media asset. The user may pause the media asset at the particular frame. The user may then select an article of clothing featured in the frame using a user input device.

In some embodiments, the interactive media guidance application identifies the frame in the media asset that includes the article of clothing worn by the celebrity by receiving, from the media source, metadata associated with the media asset, extracting from the metadata an indication of the frame in the media asset that includes the article of clothing, and identifying the frame in the media asset and the included article of clothing worn by the celebrity based on the indication. For example, the interactive media guidance application may receive metadata from a media source providing the media asset. The metadata indicates identifiers for one or more articles of clothing featured in the media asset. For example, the metadata may indicate identifiers for each article of clothing in a particular frame of the media asset. The identifier may be a bar code, a serial number, an image of the article of clothing, or any other suitable identifier for uniquely identifying the article of clothing.

In some embodiments, the interactive media guidance application determines the identifier for the article of clothing in the identified frame by retrieving, from a database, identifiers for a plurality of articles of clothing, comparing each article of clothing in the plurality of articles of clothing with the article of clothing in the identified frame, identifying an article of clothing in the plurality of articles of clothing with the article of clothing in the identified frame, and assigning the identifier for the article of clothing in the identified frame based on the comparison.

In some embodiments, the interactive media guidance application determines the identifier for the article of clothing in the identified frame by receiving, from a user input device, one or more features identifying the article of clothing. The interactive media guidance application transmits to a database the one or more features identifying the article of clothing. The interactive media guidance application receives from the database a plurality of matching identifiers for the one or more features. The interactive media guidance application receives, from the user input device, a selection of the identifier for the article of clothing from the plurality of matching identifiers. The interactive media guidance application assigns the selected identifier for the article of clothing in the identified frame.

In some embodiments, the interactive media guidance application determines whether the user viewing the media asset is in possession of the article of clothing based on the identifier by transmitting to a user database an instruction requesting whether the identifier for the article of clothing is present in the user database. The interactive media guidance application receives from the user database a response indicating whether the identifier for the article of clothing is present in the user database. The interactive media guidance application determines whether the user viewing the media asset is in possession of the article of clothing based on the response from the user database. For example, if the interactive media guidance application receives a response indicating the article of clothing is present in the user database, the interactive media guidance application informs the user accordingly. The interactive media guidance application may provide the user an option to retrieve additional information from the user database regarding the article of clothing in his or her possession. For example, the identified article of clothing may be present in a closet, a storage space, a particular room, or any other suitable space where the user may have stored the article of clothing in his or her possession.

In some embodiments, the interactive media guidance application determines the location for acquiring the article of clothing by transmitting to a location database the identifier for the article of clothing. The interactive media guidance application receives from the location database a plurality of available locations for acquiring the article of clothing. The interactive media guidance application identifies the location for acquiring the article of clothing from the plurality of available locations based on the user's preferences. For example, the interactive media guidance application may determine the location based on the user's preferences, such as preferred retailers, the user's location, the user's budget, or any other suitable preferences. Alternatively or additionally, the interactive media guidance application provides the user access to one or more online retailer websites for acquiring the article of clothing.

In some embodiments, the interactive media guidance application determines the location for acquiring the article of clothing by transmitting to a user database an instruction requesting clothing present in the user database that is similar to the article of clothing. The interactive media guidance application receives from the user database one or more identifiers for clothing present in the user database that is similar to the article of clothing. For example, the interactive media guidance application may determine the similar articles of clothing based on the retailer, the size, the style, or another suitable feature of the article of clothing worn by the celebrity featured in the media asset. The interactive media guidance application may determine a location for the user to acquire the similar article of clothing based on the user's preferences, such as preferred retailers, the user's location, the user's budget, or any other suitable preferences. The interactive media guidance application may optionally broaden the parameters specified in the user's preferences if too few or no locations for the user to acquire the similar article of clothing are found.

In some embodiments, in response to determining that the user is in possession of the article of clothing, the interactive media guidance application transmits, to a user database, an instruction requesting the location for the article of clothing based on the identifier. The interactive media guidance application receives, from the user database, a response indicating the location for the article of clothing. The interactive media guidance application generates for display, using the control circuitry, the location for the user based on the response from the user database.

In some embodiments, the interactive media guidance application receives, from a user input device, an indication that the identifier for the article of clothing is incorrect and a corrected identifier for the article of clothing. In response to receiving the indication, the interactive media guidance application replaces the identifier for the article with the corrected identifier. If the user finds the information to be erroneous, the user can input a correction via the interactive media guidance application. In some embodiments, the interactive media guidance application updates the information depending on the likelihood of the user's feedback being helpful. This may avoid situations where the user has intentionally or carelessly input incorrect updates for the information. For example, if a number of users input the same correction for the information, the interactive media guidance application may update the information. In another example, if the user providing the correction has a high reputation score, the interactive media guidance application may update the information.

Conventional interactive media guidance systems do not provide for syncing a user's wardrobe with fashion trends in a television program the user follows. The systems and methods described herein provide for an interactive media guidance application that keeps track of the user's wardrobe and enables the user to search for and/or update his or her wardrobe with articles of clothing featured in a television program the user follows. The systems and methods described herein determine identifiers for articles of clothing featured in a television program and compare the identifiers to identifiers in the user's wardrobe to determine if the user is already in possession of the article of clothing. If the user is not in possession of the article of clothing, the systems and methods described herein determine a location for the user to acquire the article of clothing. Even if conventional interactive media guidance systems were to provide information regarding articles of clothing featured in a television program, the user would still be unable to determine whether he or she is in possession of the article of clothing without manually checking his or her wardrobe.

It should be noted that the systems, methods, apparatuses, and/or aspects described above may be applied to, or used in accordance with, other systems, methods, apparatuses, and/or aspects.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a display screen generated by a media guidance application in accordance with some embodiments of the disclosure;

FIG. 2 shows another illustrative example of a display screen generated by a media guidance application in accordance with some embodiments of the disclosure;

FIG. 3 shows yet another illustrative example of a display screen generated by a media guidance application in accordance with some embodiments of the disclosure;

FIG. 4 shows yet another illustrative example of a display screen generated by a media guidance application in accordance with some embodiments of the disclosure;

FIG. 5 shows yet another illustrative example of a display screen generated by a media guidance application in accordance with some embodiments of the disclosure;

FIG. 6 shows yet another illustrative example of a display screen generated by a media guidance application in accordance with some embodiments of the disclosure;

FIG. 7 shows yet another illustrative example of a display screen generated by a media guidance application in accordance with some embodiments of the disclosure;

FIG. 8 is a block diagram of an illustrative user equipment device in accordance with some embodiments of the disclosure;

FIG. 9 is a block diagram of an illustrative media system in accordance with some embodiments of the disclosure;

FIG. 10 is a flowchart of illustrative steps for acquiring an article of clothing worn by a celebrity featured in a media asset in accordance with some embodiments of the disclosure;

FIG. 11 is a flowchart of an illustrative process for determining an identifier for the article of clothing in the identified frame in accordance with some embodiments of the disclosure; and

FIG. 12 is a flowchart of an illustrative process for determining a location for acquiring the article of clothing worn by a celebrity featured in the media asset in accordance with some embodiments of the disclosure.

### DETAILED DESCRIPTION

Systems and methods for acquiring an article of clothing worn by a celebrity featured in a media asset are described herein. In some aspects, the media asset featuring the celebrity is received from a media source. A frame is identified in the media asset that includes the article of clothing worn by the celebrity. An identifier is determined for the article of clothing in the identified frame. If the user is determined to be in possession of the article of clothing, an instruction is transmitted requesting the location for the article of clothing based on the identifier. The location is generated for display to the user based on a response to the instruction. If the user is determined to not be in possession of the article of clothing, a location is determined for acquiring the article of clothing. The location to acquire the article of clothing is generated for display to the user.

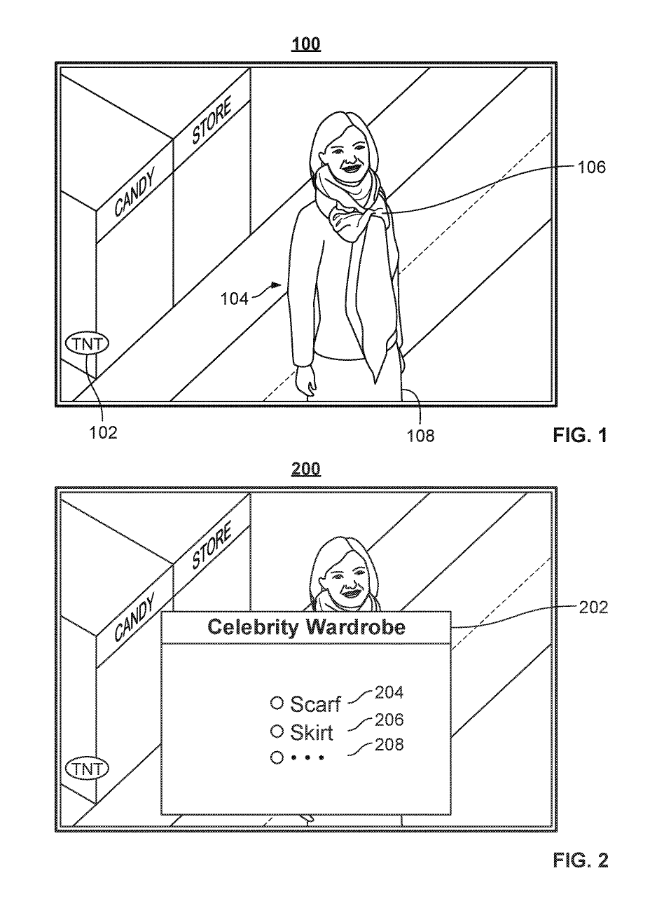

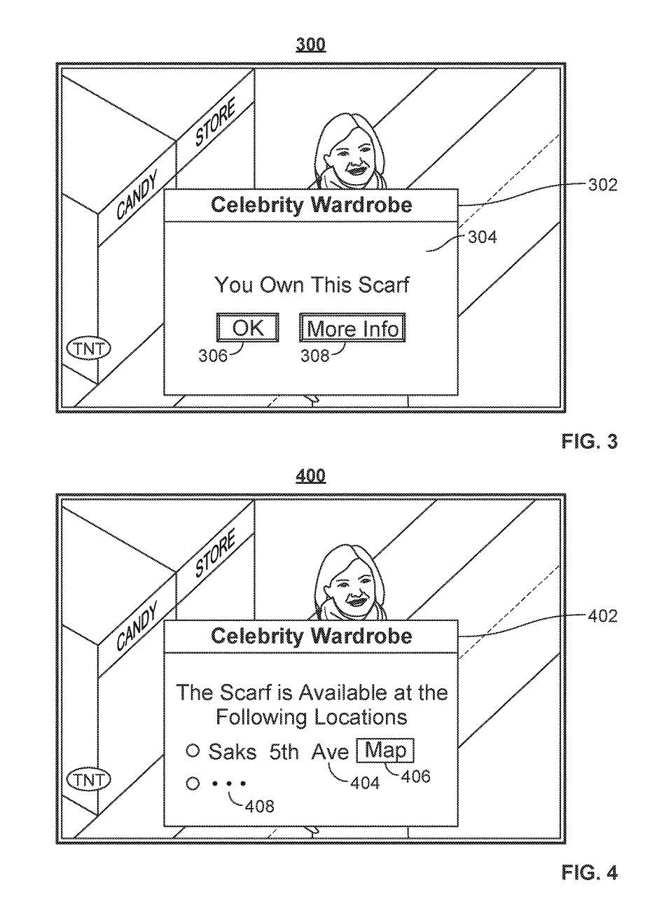

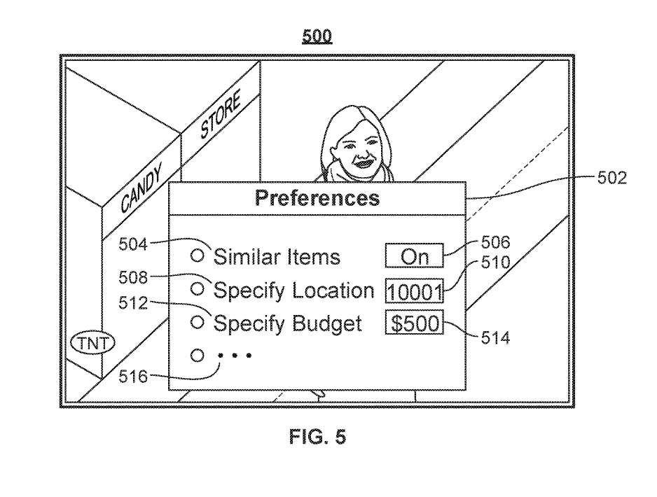

FIGS. 1-5 show illustrative examples of a display screen generated by an interactive media guidance application for acquiring an article of clothing worn by a celebrity featured in a media asset. The interactive media guidance application may be implemented in one or more of a television set-top box, a mobile phone, a tablet computer, or another suitable device. In display screen 100, a user watching a television program provided by content provider 102 and featuring celebrity 104 wearing a particular article of clothing, such as scarf 106 and skirt 108, may be interested in the article of clothing. For example, the viewer may be interested in learning more about the article of clothing. The user may select an option in the interactive media guidance application for acquiring an article of clothing worn by a celebrity featured in the media asset.

The interactive media guidance application may receive a user selection of a frame in the media asset. For example, the user may pause the media asset at the particular frame in display screen 100. The user may select an article of clothing featured in the frame, such as scarf 106 or skirt 108, using a user input device. The interactive media guidance application may retrieve an identifier for the selected article of clothing from metadata associated with the media asset. Alternatively or additionally, the interactive media guidance application may apply an image recognition algorithm to the particular frame to recognize the selected article of clothing. The interactive media guidance application may transmit the results of the image recognition algorithm to a clothing database and request an identifier for the article of clothing from the clothing database.

In display screen 200, the user receives information screen 202 regarding the wardrobe of the celebrity featured in the media asset, such as scarf 204, skirt 206, or any other suitable article of clothing 208. When the user of the interactive media guidance application expresses an interest in an article of clothing worn by a celebrity featured in the current media asset, e.g., by selecting scarf 204 or skirt 206, the interactive media guidance application determines an identifier for the article of clothing to assist the user in acquiring the article of clothing. The interactive media guidance application may receive metadata from a media source providing the media asset. The metadata indicates identifiers for one or more articles of clothing featured in the media asset, such as scarf 204 and skirt 206. For example, the metadata may indicate identifiers for each article of clothing, such as scarf 204 and skirt 206, in the particular frame of the media asset. The identifier may be a bar code, a serial number, an image of the article of clothing, or any other suitable identifier for uniquely identifying the article of clothing.

In display screen 300, the interactive media guidance application determines whether the user is in possession of the identified article of clothing. The interactive media guidance application may transmit the identifier to a user database and request whether the user database includes the article of clothing associated with the identifier. If the interactive media guidance application receives a response indicating the article of clothing is present in the user database, the interactive media guidance application informs the user accordingly via prompt 304 in information screen 302. The interactive media guidance application may provide the user option 308 to retrieve additional information from the user database regarding the article of clothing in his or her possession. Alternatively, the user may dismiss prompt 304 by selecting option 306. The user database may be stored locally in the same memory as the interactive media guidance application or in another memory remote from the interactive media guidance application.

The user database stores identifiers and any other additional information for articles of clothing in the user's possession. The user database may receive information for updating the articles of clothing in the user's possession in the form of a bar code, a serial number, an image of the article of clothing, a retailer name, a style or clothing line, a size, or any other suitable information for identifying the article of clothing. The user database may help identify which articles of clothing being worn by the celebrity featured in a media asset are in the user's possession and assist the user in achieving the same or similar look. The user database may also assist in identifying which articles of clothing are not in the user's possession and need to be acquired for the user to complete the same or similar look as the celebrity featured in the media asset.

In display screen 400, the interactive media guidance application determines that the user is not in possession of the article of clothing worn by the celebrity featured in the media asset. The interactive media guidance application determines locations 404 and 408 for the user to acquire the article of clothing. The interactive media guidance application provides information screen 402 with locations 404 and 408. Additionally, the information screen 402 includes a link to more information about the location such as map 406.

In display screen 500, the interactive media guidance application provides options for determining the location based on user preferences screen 502, such as preferred retailers, the user's location, the user's budget, or any other suitable preferences. Alternatively or additionally, the interactive media guidance application provides the user access to one or more online retailer websites for acquiring the article of clothing. For example, the user may select option 504 to enable (“ON” option 506) searching for items similar to the selected article of clothing. The user may select option 508 to specify a location 510 that the user prefers to shop. The user may select option 512 to specify a budget 514 that the user may want to comply with. The user may specify any other suitable user preferences 516 via user preferences screen 502.

If the user selects option 504 to enable (“ON” option 506) searching for items similar to the selected article of clothing, the interactive media guidance application determines one or more articles of clothing similar to the article of clothing worn by the celebrity featured in the media asset. The interactive media guidance application determines the similar articles of clothing based on the retailer, the size, the style, or another suitable feature of the article of clothing worn by the celebrity featured in the media asset. The interactive media guidance application may determine a location for the user to acquire the similar article of clothing based on the user's preferences, such as preferred retailers, the user's location 508, 510, the user's budget 512, 514, or any other suitable preferences.

In some embodiments, information regarding the articles of clothing worn by a celebrity featured in a media asset are provided by one or more of the content provider, the service provider, the retailer for each article of clothing, or another suitable third party. The service provider may generate revenue from sales of the article of clothing and/or advertising the articles of clothing for the respective retailers. The service provider may use the ability for the viewer to purchase featured articles of clothing as a selling feature for their service. The service provider may contract with retailers to include television programs in their schedule that feature articles of clothing sold by the retailers.

In some embodiments, information regarding the articles of clothing worn by a celebrity featured in a media asset are specified by the content provider, the service provider, the retailer for each article of clothing, or another suitable third party. In some embodiments, information regarding the articles of clothing worn by a celebrity featured in a media asset is manually input by one or more users of the interactive media guidance application. In some embodiments, information regarding the articles of clothing worn by a celebrity featured in a media asset is automatically determined based on image recognition of the articles of clothing via image recognition algorithms. In some embodiments, errors in information regarding the articles of clothing worn by a celebrity featured in a media asset are corrected via user feedback. If the user finds the information to be erroneous, the user can input a correction via the interactive media guidance application. The interactive media guidance application may update the information depending on the likelihood of the user's feedback being helpful. This may avoid situations where the user has intentionally or carelessly input incorrect updates for the information. For example, if a number of users input the same correction for the information, the interactive media guidance application may update the information. In another example, if the user providing the correction has a high reputation score, the interactive media guidance application may update the information.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), on-demand information, blogs, websites, and any other type of guidance data that is helpful for a user to navigate among and locate desired content selections.

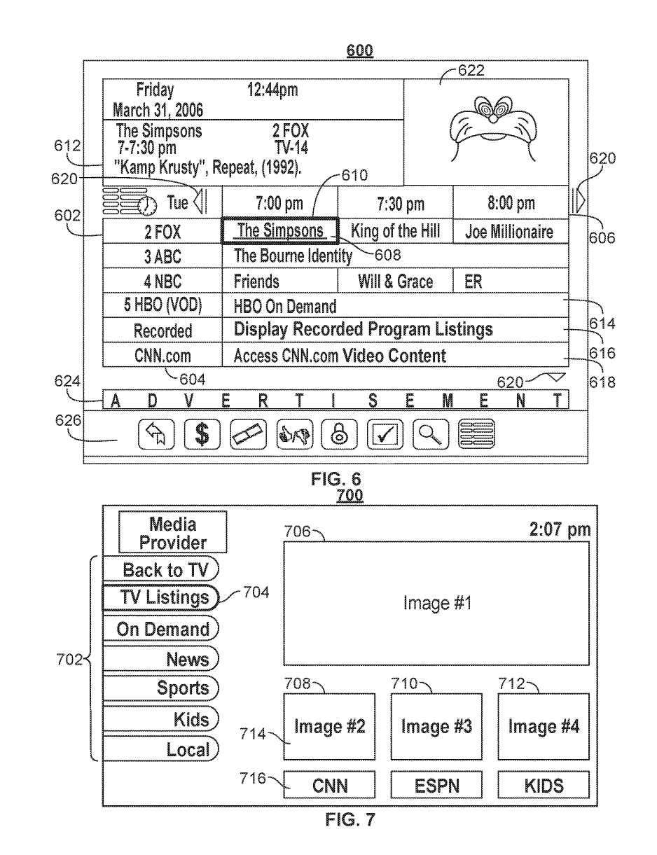

FIGS. 6-7 show illustrative display screens that may be used to provide media guidance data. The display screens shown in FIGS. 6-7 may be implemented on any suitable user equipment device or platform. While the displays of FIGS. 6-7 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 6 shows illustrative grid of a program listings display 600 arranged by time and channel that also enables access to different types of content in a single display. Display 600 may include grid 602 with: (1) a column of channel/content type identifiers 604, where each channel/content type identifier (which is a cell in the column) identifies a different channel or content type available; and (2) a row of time identifiers 606, where each time identifier (which is a cell in the row) identifies a time block of programming. Grid 602 also includes cells of program listings, such as program listing 608, where each listing provides the title of the program provided on the listing's associated channel and time. With a user input device, a user can select program listings by moving highlight region 610. Information relating to the program listing selected by highlight region 610 may be provided in program information region 612. Region 612 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO On Demand is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 602 may provide media guidance data for non-linear programming including on-demand listing 614, recorded content listing 616, and Internet content listing 618. A display combining media guidance data for content from different types of content sources is sometimes referred to as a “mixed-media” display. Various permutations of the types of media guidance data that may be displayed that are different than display 600 may be based on user selection or guidance application definition (e.g., a display of only recorded and broadcast listings, only on-demand and broadcast listings, etc.). As illustrated, listings 614, 616, and 618 are shown as spanning the entire time block displayed in grid 602 to indicate that selection of these listings may provide access to a display dedicated to on-demand listings, recorded listings, or Internet listings, respectively. In some embodiments, listings for these content types may be included directly in grid 602. Additional media guidance data may be displayed in response to the user selecting one of the navigational icons 620. (Pressing an arrow key on a user input device may affect the display in a similar manner as selecting navigational icons 620.)

Display 600 may also include video region 622, and options region 626. Video region 622 may allow the user to view and/or preview programs that are currently available, will be available, or were available to the user. The content of video region 622 may correspond to, or be independent from, one of the listings displayed in grid 602. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Options region 626 may allow the user to access different types of content, media guidance application displays, and/or media guidance application features. Options region 626 may be part of display 600 (and other display screens described herein), or may be invoked by a user by selecting an on-screen option or pressing a dedicated or assignable button on a user input device. The selectable options within options region 626 may concern features related to program listings in grid 602 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the

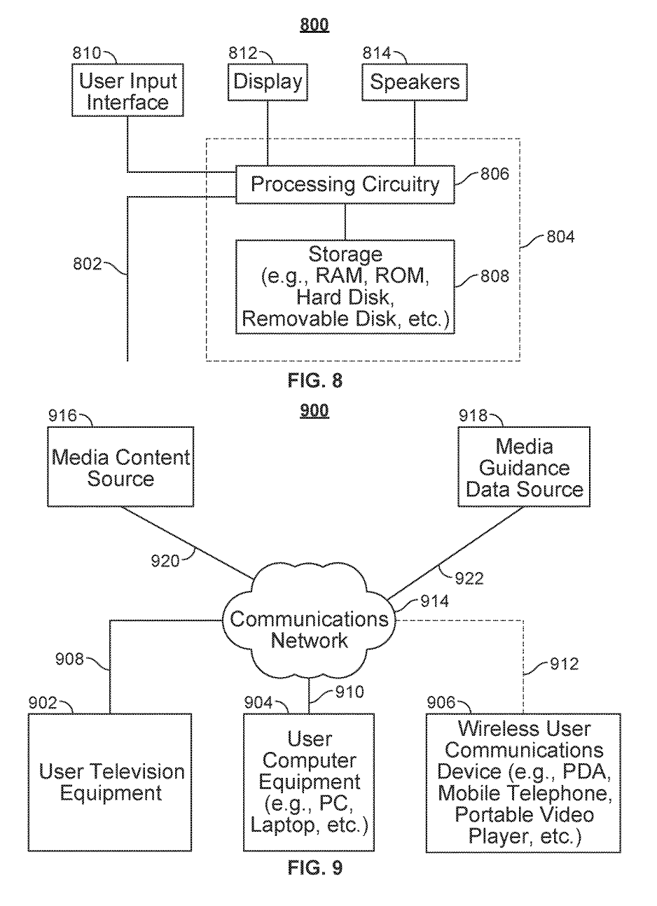

Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 9. Additional personalized media guidance application features are described in greater detail in Ellis et al., U.S. Patent Application publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 7. Video mosaic display 700 includes selectable options 702 for content information organized based on content type, genre, and/or other organization criteria. In display 700, television listings option 704 is selected, thus providing listings 706, 708, 710, and 712 as broadcast program listings. In display 700 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 708 may include more than one portion, including media portion 714 and text portion 716. Media portion 714 and/or text portion 716 may be selectable to view content in full-screen or to view information related to the content displayed in media portion 714 (e.g., to view listings for the channel that the video is displayed on).

The listings in display 700 are of different sizes (i.e., listing 706 is larger than listings 708, 710, and 712), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

Users may access content and the media guidance application (and its display screens described above and below) from one or more of their user equipment devices. FIG. 8 shows a generalized embodiment of illustrative user equipment device 800. More specific implementations of user equipment devices are discussed below in connection with FIG. 9. User equipment device 800 may receive content and data via input/output (hereinafter “I/O”) path 802. I/O path 802 may provide content (e.g., broadcast programming, on-demand programming, Internet content, content available over a local area network (LAN) or wide area network (WAN), and/or other content) and data to control circuitry 804, which includes processing circuitry 806 and storage 808. Control circuitry 804 may be used to send and receive commands, requests, and other suitable data using I/O path 802. I/O path 802 may connect control circuitry 804 (and specifically processing circuitry 806) to one or more communications paths (described below). I/O functions may be provided by one or more of these communications paths, but are shown as a single path in FIG. 8 to avoid overcomplicating the drawing.

Control circuitry 804 may be based on any suitable processing circuitry such as processing circuitry 806. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 804 executes instructions for a media guidance application stored in memory (i.e., storage 808). Specifically, control circuitry 804 may be instructed by the media guidance application to perform the functions discussed above and below. For example, the media guidance application may provide instructions to control circuitry 804 to generate the media guidance displays. In some implementations, any action performed by control circuitry 804 may be based on instructions received from the media guidance application.

In client-server based embodiments, control circuitry 804 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 9). In addition, communications circuitry may include circuitry that enables peer-to-peer communication of user equipment devices, or communication of user equipment devices in locations remote from each other (described in more detail below).

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 808 may be used to store various types of content described herein as well as media guidance data described above. Nonvolatile memory may also be used (e.g., to launch a boot-up routine and other instructions). Cloud-based storage, described in relation to FIG. 9, may be used to supplement storage 808 or instead of storage 808.

Control circuitry 804 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 804 may also include scaler circuitry for upconverting and downconverting content into the preferred output format of the user equipment 800. Circuitry 804 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 808 is provided as a separate device from user equipment 800, the tuning and encoding circuitry (including multiple tuners) may be associated with storage 808.

A user may send instructions to control circuitry 804 using user input interface 810. User input interface 810 may be any suitable user interface, such as a remote control, mouse, trackball, keypad, keyboard, touch screen, touchpad, stylus input, joystick, voice recognition interface, or other user input interfaces. Display 812 may be provided as a stand-alone device or integrated with other elements of user equipment device 800. For example, display 812 may be a touchscreen or touch-sensitive display. In such circumstances, user input interface 810 may be integrated with or combined with display 812. Display 812 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 812 may be HDTV-capable. In some embodiments, display 812 may be a 3D display, and the interactive media guidance application and any suitable content may be displayed in 3D. A video card or graphics card may generate the output to the display 812. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 804. The video card may be integrated with the control circuitry 804. Speakers 814 may be provided as integrated with other elements of user equipment device 800 or may be stand-alone units. The audio component of videos and other content displayed on display 812 may be played through speakers 814. In some embodiments, the audio may be distributed to a receiver (not shown), which processes and outputs the audio via speakers 814.

The guidance application may be implemented using any suitable architecture. For example, it may be a stand-alone application wholly-implemented on user equipment device 800. In such an approach, instructions of the application are stored locally (e.g., in storage 808), and data for use by the application is downloaded on a periodic basis (e.g., from an out-of-band feed, from an Internet resource, or using another suitable approach). Control circuitry 804 may retrieve instructions of the application from storage 808 and process the instructions to generate any of the displays discussed herein. Based on the processed instructions, control circuitry 804 may determine what action to perform when input is received from input interface 810. For example, movement of a cursor on a display up/down may be indicated by the processed instructions when input interface 810 indicates that an up/down button was selected.

In some embodiments, the media guidance application is a client-server based application. Data for use by a thick or thin client implemented on user equipment device 800 is retrieved on-demand by issuing requests to a server remote to the user equipment device 800. In one example of a client-server based guidance application, control circuitry 804 runs a web browser that interprets web pages provided by a remote server. For example, the remote server may store the instructions for the application in a storage device. The remote server may process the stored instructions using circuitry (e.g., control circuitry 804) and generate the displays discussed above and below. The client device may receive the displays generated by the remote server and may display the content of the displays locally on equipment device 800. This way, the processing of the instructions is performed remotely by the server while the resulting displays are provided locally on equipment device 800. Equipment device 800 may receive inputs from the user via input interface 810 and transmit those inputs to the remote server for processing and generating the corresponding displays. For example, equipment device 800 may transmit a communication to the remote server indicating that an up/down button was selected via input interface 810. The remote server may process instructions in accordance with that input and generate a display of the application corresponding to the input (e.g., a display that moves a cursor up/down). The generated display is then transmitted to equipment device 800 for presentation to the user.

In some embodiments, the media guidance application is downloaded and interpreted or otherwise run by an interpreter or virtual machine (run by control circuitry 804). In some embodiments, the guidance application may be encoded in the ETV Binary Interchange Format (EBIF), received by control circuitry 804 as part of a suitable feed, and interpreted by a user agent running on control circuitry 804. For example, the guidance application may be an EBIF application. In some embodiments, the guidance application may be defined by a series of JAVA-based files that are received and run by a local virtual machine or other suitable middleware executed by control circuitry 804. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 800 of FIG. 8 can be implemented in system 900 of FIG. 9 as user television equipment 902, user computer equipment 904, wireless user communications device 906, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 8 may not be classified solely as user television equipment 902, user computer equipment 904, or a wireless user communications device 906. For example, user television equipment 902 may, like some user computer equipment 904, be Internet-enabled allowing for access to Internet content, while user computer equipment 904 may, like some television equipment 902, include a tuner allowing for access to television programming. The media guidance application may have the same layout on various different types of user equipment or may be tailored to the display capabilities of the user equipment. For example, on user computer equipment 904, the guidance application may be provided as a web site accessed by a web browser. In another example, the guidance application may be scaled down for wireless user communications devices 906.

In system 900, there is typically more than one of each type of user equipment device but only one of each is shown in FIG. 9 to avoid overcomplicating the drawing. In addition, each user may utilize more than one type of user equipment device and also more than one of each type of user equipment device.

In some embodiments, a user equipment device (e.g., user television equipment 902, user computer equipment 904, wireless user communications device 906) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 914. Namely, user television equipment 902, user computer equipment 904, and wireless user communications device 906 are coupled to communications network 914 via communications paths 908, 910, and 912, respectively. Communications network 914 may be one or more networks including the Internet, a mobile phone network, mobile voice or data network (e.g., a 4G or LTE network), cable network, public switched telephone network, or other types of communications network or combinations of communications networks. Paths 908, 910, and 912 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 912 is drawn with dotted lines to indicate that in the exemplary embodiment shown in FIG. 9 it is a wireless path and paths 908 and 910 are drawn as solid lines to indicate they are wired paths (although these paths may be wireless paths, if desired). Communications with the user equipment devices may be provided by one or more of these communications paths, but are shown as a single path in FIG. 9 to avoid overcomplicating the drawing.

Although communications paths are not drawn between user equipment devices, these devices may communicate directly with each other via communication paths, such as those described above in connection with paths 908, 910, and 912, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 914.

System 900 includes content source 916 and media guidance data source 918 coupled to communications network 914 via communication paths 920 and 922, respectively. Paths 920 and 922 may include any of the communication paths described above in connection with paths 908, 910, and 912. Communications with the content source 916 and media guidance data source 918 may be exchanged over one or more communications paths, but are shown as a single path in FIG. 9 to avoid overcomplicating the drawing. In addition, there may be more than one of each of content source 916 and media guidance data source 918, but only one of each is shown in FIG. 9 to avoid overcomplicating the drawing. (The different types of each of these sources are discussed below.) If desired, content source 916 and media guidance data source 918 may be integrated as one source device. Although communications between sources 916 and 918 with user equipment devices 902, 904, and 906 are shown as through communications network 914, in some embodiments, sources 916 and 918 may communicate directly with user equipment devices 902, 904, and 906 via communication paths (not shown) such as those described above in connection with paths 908, 910, and 912.

Content source 916 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 916 may be the originator of content (e.g., a television broadcaster, a Webcast provider, etc.) or may not be the originator of content (e.g., an on-demand content provider, an Internet provider of content of broadcast programs for downloading, etc.). Content source 916 may include cable sources, satellite providers, on-demand providers, Internet providers, over-the-top content providers, or other providers of content. Content source 916 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 918 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

Media content source 916, media guidance data source 918, or another suitable database includes a user database that stores identifiers and any other additional information for articles of clothing in the user's possession. The user database may receive information for updating the articles of clothing in the user's possession in the form of a bar code, a serial number, an image of the article of clothing, a retailer name, a style or clothing line, a size, or any other suitable information for identifying the article of clothing. The user database may help identify which articles of clothing being worn by the celebrity featured in a media asset are in the user's possession and assist the user in achieving the same or similar look. The user database may also assist in identifying which articles of clothing are not in the user's possession and need to be acquired for the user to complete the same or similar look as the celebrity featured in the media asset.

In some embodiments, guidance data from media guidance data source 918 may be provided to users's equipment using a client-server approach. For example, a user equipment device may pull media guidance data from a server, or a server may push media guidance data to a user equipment device. In some embodiments, a guidance application client residing on the user's equipment may initiate sessions with source 918 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 918 may provide user equipment devices 902, 904, and 906 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 808, and executed by control circuitry 804 of a user equipment device 800. In some embodiments, media guidance applications may be client-server applications where only a client application resides on the user equipment device, and server application resides on a remote server. For example, media guidance applications may be implemented partially as a client application on control circuitry 804 of user equipment device 800 and partially on a remote server as a server application (e.g., media guidance data source 918) running on control circuitry of the remote server. When executed by control circuitry of the remote server (such as media guidance data source 918), the media guidance application may instruct the control circuitry to generate the guidance application displays and transmit the generated displays to the user equipment devices. The server application may instruct the control circuitry of the media guidance data source 918 to transmit data for storage on the user equipment. The client application may instruct control circuitry of the receiving user equipment to generate the guidance application displays.

Content and/or media guidance data delivered to user equipment devices 902, 904, and 906 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 900 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 9.

In one approach, user equipment devices may communicate with each other within a home network. User equipment devices can communicate with each other directly via short-range point-to-point communication schemes described above, via indirect paths through a hub or other similar device provided on a home network, or via communications network 914. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 916 to access content. Specifically, within a home, users of user television equipment 902 and user computer equipment 904 may access the media guidance application to navigate among and locate desirable content. Users may also access the media guidance application outside of the home using wireless user communications devices 906 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 914. These cloud resources may include one or more content sources 916 and one or more media guidance data sources 918. In addition or in the alternative, the remote computing sites may include other user equipment devices, such as user television equipment 902, user computer equipment 904, and wireless user communications device 906. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 904 or wireless user communications device 906 having content capture feature. Alternatively, the user can first transfer the content to a user equipment device, such as user computer equipment 904. The user equipment device storing the content uploads the content to the cloud using a data transmission service on communications network 914. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 8.

As referred herein, the term “in response to” refers to initiated as a result of. For example, a first action being performed in response to a second action may include interstitial steps between the first action and the second action. As referred herein, the term “directly in response to” refers to caused by. For example, a first action being performed directly in response to a second action may not include interstitial steps between the first action and the second action.

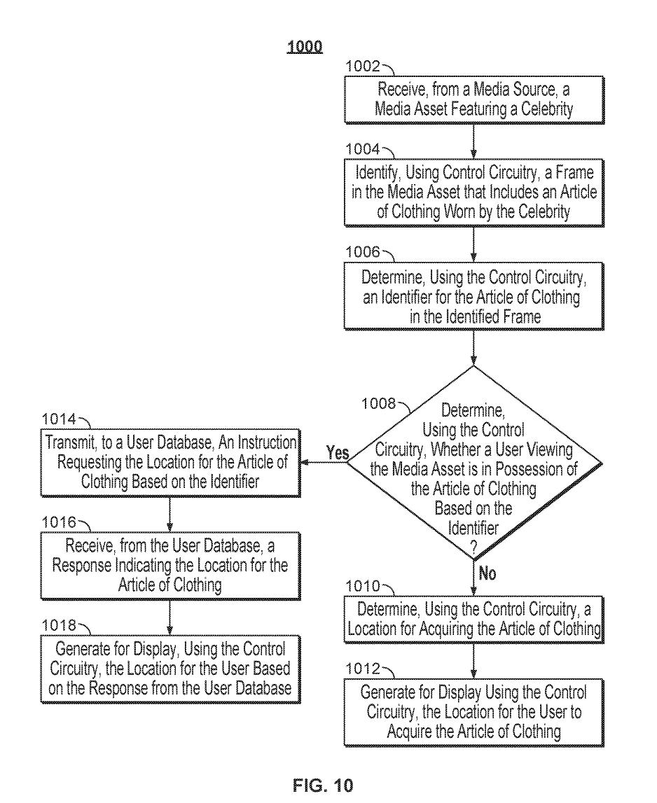

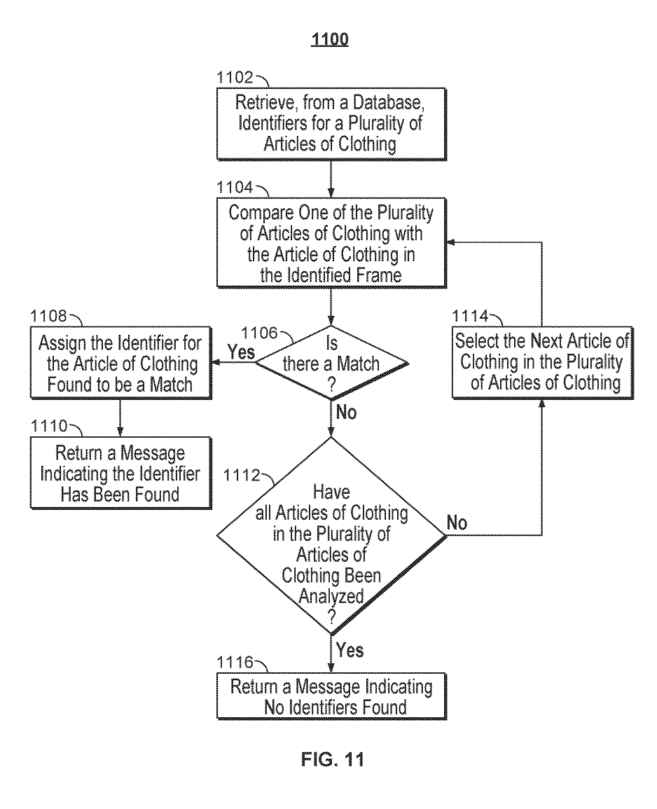

FIG. 10 is a flowchart of illustrative steps for acquiring an article of clothing worn by a celebrity featured in a media asset in accordance with some embodiments of the disclosure. FIG. 10 presents a process for control circuitry (e.g., control circuitry 804) to assist a user of an interactive media guidance application to acquire an article of clothing worn by a celebrity featured in a media asset in accordance with some embodiments of the disclosure. In some embodiments this algorithm may be encoded on to non-transitory storage medium (e.g., storage device 808) as a set of instructions to be decoded and executed by processing circuitry (e.g., processing circuitry 806). Processing circuitry may in turn provide instructions to other sub-circuits contained within control circuitry 804, such as the tuning, video generating, encoding, decoding, encrypting, decrypting, scaling, analog/digital conversion circuitry, and the like.

At step 1002, control circuitry 804 receives, from a media source (e.g., media content source 916 or another suitable media source), the media asset featuring the celebrity. At step 1004, control circuitry 804 identifies a frame in the media asset that includes the article of clothing worn by the celebrity.

In some embodiments, control circuitry 804 identifies the frame in the media asset that includes the article of clothing worn by the celebrity by receiving, from a user input device (e.g., user input interface 810), a first selection identifying the frame in the media asset and a second selection identifying the article of clothing worn by the celebrity included in the frame. For example, control circuitry 804 receives a user selection of a frame in the media asset. The user may pause the media asset at the particular frame. The user may then select an article of clothing featured in the frame using a user input device.

In some embodiments, control circuitry 804 identifies the frame in the media asset that includes the article of clothing worn by the celebrity by receiving, from the media source (e.g., media content source 916), metadata associated with the media asset, extracting from the metadata an indication of the frame in the media asset that includes the article of clothing, and identifying the frame in the media asset and the included article of clothing worn by the celebrity based on the indication. For example, control circuitry 804 may receive metadata from a media source providing the media asset. The metadata indicates identifiers for one or more articles of clothing featured in the media asset. For example, the metadata may indicate identifiers for each article of clothing in a particular frame of the media asset. The identifier may be a bar code, a serial number, an image of the article of clothing, or any other suitable identifier for uniquely identifying the article of clothing.

At step 1006, control circuitry 804 determines an identifier for the article of clothing in the identified frame. In some embodiments, control circuitry 804 determines the identifier for the article of clothing in the identified frame by retrieving, from a database (e.g., media content source 916, media guidance data source 918, or another suitable database), identifiers for a plurality of articles of clothing, comparing each article of clothing in the plurality of articles of clothing with the article of clothing in the identified frame, identifying an article of clothing in the plurality of articles of clothing with the article of clothing in the identified frame, and assigning the identifier for the article of clothing in the identified frame based on the comparison.

In some embodiments, control circuitry 804 determines the identifier for the article of clothing in the identified frame by receiving, from a user input device (e.g., user input interface 810), one or more features identifying the article of clothing. Control circuitry 804 transmits to a database the one or more features identifying the article of clothing. Control circuitry 804 receives from the database a plurality of matching identifiers for the one or more features. Control circuitry 804 receives, from the user input device (e.g., user input interface 810), a selection of the identifier for the article of clothing from the plurality of matching identifiers. Control circuitry 804 assigns the selected identifier for the article of clothing in the identified frame.

At step 1008, control circuitry 804 determines whether a user viewing the media asset is in possession of the article of clothing based on the identifier. For example, the viewer may be interested in learning more about the article of clothing. Particularly, the viewer may be interested in acquiring the article of clothing for his or her wardrobe. Or the viewer may benefit from being reminded that the particular article of clothing the viewer is interested in is already present in his or her wardrobe.

In some embodiments, control circuitry 804 determines whether the user viewing the media asset is in possession of the article of clothing based on the identifier by transmitting to a user database (e.g., media content source 916, media guidance data source 918, or another suitable database) an instruction requesting whether the identifier for the article of clothing is present in the user database. Control circuitry 804 receives from the user database a response indicating whether the identifier for the article of clothing is present in the user database. Control circuitry 804 determines whether the user viewing the media asset is in possession of the article of clothing based on the response from the user database. For example, if control circuitry 804 receives a response indicating the article of clothing is present in the user database, control circuitry 804 informs the user accordingly. Control circuitry 804 may provide the user an option to retrieve additional information from the user database regarding the article of clothing in his or her possession.

At step 1010, in response to determining that the user is not in possession of the article of clothing, control circuitry 804 determines a location for acquiring the article of clothing. At step 1012, control circuitry 804 generates for display the location for the user to acquire the article of clothing. For example, the interactive media guidance application may determine the location based on the user's preferences, such as preferred retailers, the user's location, the user's budget, or any other suitable preferences. Alternatively or additionally, the interactive media guidance application provides the user access to one or more online retailer websites for acquiring the article of clothing.

In some embodiments, control circuitry 804 determines the location for acquiring the article of clothing by transmitting to a location database the identifier for the article of clothing. The interactive media guidance application receives from the location database (e.g., media content source 916, media guidance data source 918, or another suitable database) a plurality of available locations for acquiring the article of clothing. Control circuitry 804 identifies the location for acquiring the article of clothing from the plurality of available locations based on the user's preferences. For example, control circuitry 804 may determine the location based on the user's preferences, such as preferred retailers, the user's location, the user's budget, or any other suitable preferences. Alternatively or additionally, control circuitry 804 provides the user access to one or more online retailer websites for acquiring the article of clothing.

In some embodiments, control circuitry 804 determines the location for acquiring the article of clothing by transmitting to a user database (e.g., media content source 916, media guidance data source 918, or another suitable database) an instruction requesting clothing present in the user database that is similar to the article of clothing. Control circuitry 804 receives from the user database one or more identifiers for clothing present in the user database that is similar to the article of clothing. For example, control circuitry 804 may determine the similar articles of clothing based on the retailer, the size, the style, or another suitable feature of the article of clothing worn by the celebrity featured in the media asset. Control circuitry 804 may determine a location for the user to acquire the similar article of clothing based on the user's preferences, such as preferred retailers, the user's location, the user's budget, or any other suitable preferences.

At step 1014, in response to determining that the user is in possession of the article of clothing, control circuitry 804 transmits, to a user database (e.g., media content source 916, media guidance data source 918, or another suitable database), an instruction requesting the location for the article of clothing based on the identifier. At step 1016, control circuitry 804 receives, from the user database, a response indicating the location for the article of clothing. At step 1018, control circuitry 804 generates for display, using the control circuitry, the location for the user based on the response from the user database.

In some embodiments, control circuitry 804 receives, from a user input device (e.g., user input interface 810), an indication that the identifier for the article of clothing is incorrect and a corrected identifier for the article of clothing. In response to receiving the indication, control circuitry 804 replaces the identifier for the article with the corrected identifier. If the user finds the information to be erroneous, the user can input a correction via the interactive media guidance application. In some embodiments, control circuitry 804 updates the information depending on the likelihood of the user's feedback being helpful. This may avoid situations where the user has intentionally or carelessly input incorrect updates for the information. For example, if a number of users input the same correction for the information, control circuitry 804 may update the information. In another example, if the user providing the correction has a high reputation score, control circuitry 804 may update the information.

It is contemplated that the steps or descriptions of FIG. 10 may be used with any other embodiment of this disclosure. In addition, the descriptions described in relation to the algorithm of FIG. 10 may be done in alternative orders or in parallel to further the purposes of this disclosure. For example, conditional statements and logical evaluations, such as those at 1008, may be performed in any order or in parallel or simultaneously to reduce lag or increase the speed of the system or method. As a further example, in some embodiments several instances of the identifier for the article of clothing may be evaluated in parallel, using multiple logical processor threads, or the algorithm may be enhanced by incorporating branch prediction. Furthermore, it should be noted that the process of FIG. 10 may be implemented on a combination of appropriately configured software and hardware, and that any of the devices or equipment discussed in relation to FIGS. 8-9 could be used to implement one or more portions of the process.

FIG. 11 is a flowchart of an illustrative process for determining an identifier for the article of clothing in the identified frame in accordance with some embodiments of the disclosure. The illustrative process provides exemplary steps for executing step 1006 of FIG. 10. FIG. 11 presents a process for control circuitry (e.g., control circuitry 804) to determine an identifier for the article of clothing in the identified frame in accordance with some embodiments of the disclosure. In some embodiments this algorithm may be encoded on to non-transitory storage medium (e.g., storage device 808) as a set of instructions to be decoded and executed by processing circuitry (e.g., processing circuitry 806). Processing circuitry may in turn provide instructions to other sub-circuits contained within control circuitry 804, such as the tuning, video generating, encoding, decoding, encrypting, decrypting, scaling, analog/digital conversion circuitry, and the like.

At step 1102, control circuitry 804 retrieves, from a database (e.g., media content source 916, media guidance data source 918, or another suitable database), identifiers for a plurality of articles of clothing. In some embodiments, this may be done either directly or indirectly in response to a user action or input (e.g., from signals received by control circuitry 804 or user input interface 810). For example, the process may begin directly in response to control circuitry 804 receiving signals from user input interface 810, or control circuitry 804 may prompt the user to confirm their input using a display (e.g., by generating a prompt to be displayed on display 812) prior to running the algorithm.

At step 1104, control circuitry 804 proceeds to compare one of the plurality of articles of clothing with the article of clothing in the identified frame. In some embodiments, control circuitry 804 receives a single primitive data structure that represents the article of clothing. In some embodiments, the information may be stored as part of a larger data structure, and control circuitry 804 may retrieve the information by executing appropriate accessor methods to retrieve the value from the larger data structure. In some embodiments, information for the article of clothing in the identified frame may be stored (e.g., on storage device 808) prior to beginning the process. Control circuitry 804 may call a comparison function (e.g., for object to object comparison) to compare information for the articles of clothing.

At step 1106, control circuitry 804 compares information for the articles of clothing to determine if there is a match. If the condition is satisfied, the algorithm may proceed to step 1108; if the condition is not satisfied, the algorithm may proceed to step 1112 instead.

At step 1108, control circuitry 804 executes a subroutine to assign the identifier for the article of clothing found to be a match based on the condition at step 508 being satisfied. After the subroutine is executed, the algorithm may proceed to step 1110 and return a message indicating the identifier has been found and no further iterations are needed.

At step 1112, control circuitry 804 checks if all instances of the plurality of articles of clothing are accounted for. If all of the instances have been analyzed, control circuitry 804 may proceed to step 1116. For example, control circuitry 804 may call a function to see if there is a next element of the plurality of articles of clothing. If the function returns true (i.e., there are still instances that need to be processed), control circuitry 804 may proceed to step 1114 and select the next article of clothing in the plurality of articles of clothing.

At step 1116, control circuitry 804 executes a subroutine to return a message indicating that all articles of clothing have been analyzed and no identifier matching the article of clothing in the identified frame was found.

It is contemplated that the steps or descriptions of FIG. 11 may be used with any other embodiment of this disclosure. In addition, the descriptions described in relation to the algorithm of FIG. 11 may be done in alternative orders or in parallel to further the purposes of this disclosure. For example, conditional statements and logical evaluations, such as those at 1106 and 1112, may be performed in any order or in parallel or simultaneously to reduce lag or increase the speed of the system or method. As a further example, in some embodiments several instances of the plurality of articles of clothing may be evaluated in parallel, using multiple logical processor threads, or the algorithm may be enhanced by incorporating branch prediction. Furthermore, it should be noted that the process of FIG. 11 may be implemented on a combination of appropriately configured software and hardware, and that any of the devices or equipment discussed in relation to FIGS. 8-9 could be used to implement one or more portions of the process.

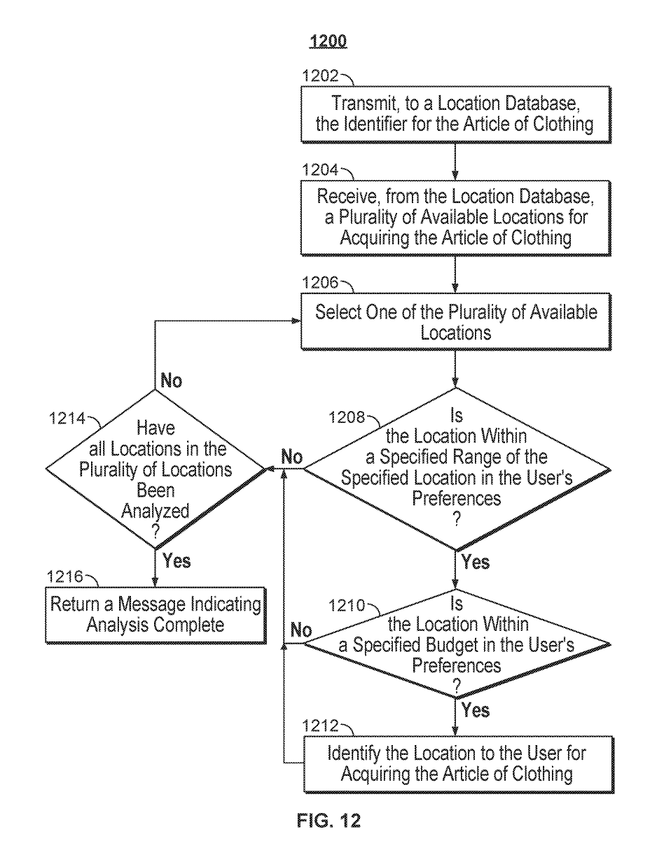

FIG. 12 is a flowchart of an illustrative process for determining a location for acquiring the article of clothing worn by a celebrity featured in a media asset in accordance with some embodiments of the disclosure. The illustrative process provides exemplary steps for executing step 1010 of FIG. 10. FIG. 12 presents a process for control circuitry (e.g., control circuitry 804) to determine a location for acquiring the article of clothing worn by a celebrity featured in a media asset in accordance with some embodiments of the disclosure. In some embodiments this algorithm may be encoded on to non-transitory storage medium (e.g., storage device 808) as a set of instructions to be decoded and executed by processing circuitry (e.g., processing circuitry 806). Processing circuitry may in turn provide instructions to other sub-circuits contained within control circuitry 804, such as the tuning, video generating, encoding, decoding, encrypting, decrypting, scaling, analog/digital conversion circuitry, and the like.

At step 1202, control circuitry 804 transmits to a location database (e.g., media content source 916, media guidance data source 918, or another suitable database) the identifier for the article of clothing. In some embodiments, this may be done either directly or indirectly in response to a user action or input (e.g., from signals received by control circuitry 804 or user input interface 810). For example, the process may begin directly in response to control circuitry 804 receiving signals from user input interface 810, or control circuitry 804 may prompt the user to confirm their input using a display (e.g., by generating a prompt to be displayed on display 812) prior to running the algorithm.

At step 1204, control circuitry 804 receives from the location database a plurality of available locations for acquiring the article of clothing. At step 1206, control circuitry 804 proceeds to retrieve the next instance of available locations from memory. In some embodiments, control circuitry 804 may receive a single primitive data structure that represents the available location. In some embodiments, the value may be stored as part of a larger data structure, and control circuitry 804 may retrieve the value by executing appropriate accessor methods to retrieve the value from the larger data structure.

At step 1208, control circuitry 804 proceeds to compare the value of the available location to the stored value of a specified location in the user's preferences. In some embodiments, the value of the specified location may be stored (e.g., on storage device 808) prior to beginning the process. In some embodiments, the value of the specified location may also be retrieved for each and every instance of the available locations, and the value of the available locations may change from iteration to iteration. In some embodiments, control circuitry 804 may directly compare the value of the available location with the value of the specified location in the user's preferences by accessing the values respectively from memory and performing a value comparison. In some instances, control circuitry 804 may call a comparison function (e.g., for object to object comparison) to compare the available location and the specified location in the user's preferences. If the condition is satisfied, the algorithm may proceed to step 1210; if the condition is not satisfied, the algorithm may proceed to step 1214 instead.

At step 1210, based on the condition at step 1208 being satisfied, control circuitry 804 proceeds to compare the value of the goods sold at the available location to the stored value of a specified budget in the user's preferences. In some embodiments, the value of the specified budget may be stored (e.g., on storage device 808) prior to beginning the process. In some embodiments, the value of the specified budget may also be retrieved for each and every instance of the available locations, and the available locations may change from iteration to iteration. In some embodiments, control circuitry 804 may directly compare the value of the goods sold at the available location with the value of the specified budget in the user's preferences by accessing the values respectively from memory and performing a value comparison. In some instances, control circuitry 804 may call a comparison function (e.g., for object to object comparison) to compare the value of goods sold at the available location and the specified budget in the user's preferences. If the condition is satisfied, the algorithm may proceed to step 1212; if the condition is not satisfied, the algorithm may proceed to step 1214 instead.

At step 1212, control circuitry 804 executes a subroutine to identify the location to the user for acquiring the article of clothing based on both of the conditions in 1208 and 1210 being satisfied. After the subroutine is executed, the algorithm may proceed to 1214 where it is determined if all instances of available locations in the plurality of available locations are accounted for and if further iterations are needed.

At step 1214, control circuitry 804 checks if all instances of available locations in the plurality of available locations are accounted for. If all of the instances have been evaluated, control circuitry 804 may proceed to step 1216. For example, control circuitry 804 may call a function to see if there is a next element in the plurality of available locations. If the function returns true (i.e., there are still instances that need to be processed), control circuitry 804 may proceed to step 1206.

At step 1216, control circuitry 804 executes a subroutine to return a message indicating that all available locations have been analyzed. In some embodiments, control circuitry 804 executes a subroutine to broaden the parameters specified in the user's preferences. Control circuitry 804 may broaden the parameters if too few or no locations are identified for the user to acquire the article of clothing. For example, control circuitry 804 may prompt the user to increase the range from the specified location in the user's preferences for selecting available locations. Alternatively, control circuitry 804 may automatically increase the range from the specified location to select additional available locations. For example, control circuitry 804 may prompt the user to increase the budget specified in the user's preferences. Alternatively, control circuitry 804 may automatically increase the budget to select additional available locations. Control circuitry may proceed to step 1206 to reprocess the available locations in view of the updated parameters in the user's preferences.

It is contemplated that the steps or descriptions of FIG. 12 may be used with any other embodiment of this disclosure. In addition, the descriptions described in relation to the algorithm of FIG. 12 may be done in alternative orders or in parallel to further the purposes of this disclosure. For example, conditional statements and logical evaluations, such as those at 1208, 1210, and 1214, may be performed in any order or in parallel or simultaneously to reduce lag or increase the speed of the system or method. As a further example, in some embodiments several instances of available locations may be evaluated in parallel, using multiple logical processor threads, or the algorithm may be enhanced by incorporating branch prediction. Furthermore, it should be noted that the process of FIG. 12 may be implemented on a combination of appropriately configured software and hardware, and that any of the devices or equipment discussed in relation to FIGS. 8-9 could be used to implement one or more portions of the process.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for acquiring an article of clothing worn by a celebrity featured in a media asset, the method comprising:
receiving, from a media source, the media asset featuring the celebrity;
identifying, using control circuitry, a frame in the media asset that includes the article of clothing worn by the celebrity;
determining, using the control circuitry, an identifier for the article of clothing in the identified frame;
determining, using the control circuitry, whether a user viewing the media asset is in possession of the article of clothing based on the identifier; and
in response to determining that the user is not in possession of the article of clothing:
determining, using the control circuitry, a location for acquiring the article of clothing; and
generating for display, using the control circuitry, the location for the user to acquire the article of clothing.

2. The method of claim 1, wherein identifying the frame in the media asset that includes the article of clothing worn by the celebrity comprises:
receiving, from a user input device, a first selection identifying the frame in the media asset;
receiving, from the user input device, a second selection identifying the article of clothing worn by the celebrity included in the frame.

3. The method of claim 1, wherein identifying the frame in the media asset that includes the article of clothing worn by the celebrity comprises:
receiving, from the media source, metadata associated with the media asset;
extracting, using the control circuitry, from the metadata an indication of the frame in the media asset that includes the article of clothing;
identifying, using the control circuitry, the frame in the media asset and the included article of clothing worn by the celebrity based on the indication.

4. The method of claim 1, wherein determining the identifier for the article of clothing in the identified frame comprises:
retrieving, from a database, identifiers for a plurality of articles of clothing;
comparing, using the control circuitry, each article of clothing in the plurality of articles of clothing with the article of clothing in the identified frame;
identifying, using the control circuitry, an article of clothing in the plurality of articles of clothing with the article of clothing in the identified frame;
assigning, using the control circuitry, the identifier for the article of clothing in the identified frame based on the comparison.

5. The method of claim 1, wherein determining the identifier for the article of clothing in the identified frame comprises:
receiving, from a user input device, one or more features identifying the article of clothing;
transmitting, to a database, the one or more features identifying the article of clothing;
receiving, from the database, a plurality of matching identifiers for the one or more features;
receiving, from the user input device, a selection of the identifier for the article of clothing from the plurality of matching identifiers;
assigning, using the control circuitry, the selected identifier for the article of clothing in the identified frame.

6. The method of claim 1, wherein determining whether the user viewing the media asset is in possession of the article of clothing based on the identifier comprises:
transmitting, to a user database, an instruction requesting whether the identifier for the article of clothing is present in the user database;
receiving, from the user database, a response indicating whether the identifier for the article of clothing is present in the user database; determining, using the control circuitry, whether the user viewing the media asset is in possession of the article of clothing based on the response from the user database.

7. The method of claim 1, wherein determining the location for acquiring the article of clothing comprises:
transmitting, to a location database, the identifier for the article of clothing;
receiving, from the location database, a plurality of available locations for acquiring the article of clothing;
identifying, using the control circuitry, the location for acquiring the article of clothing from the plurality of available locations based on the user's preferences.

8. The method of claim 1, wherein determining the location for acquiring the article of clothing comprises:
transmitting, to a user database, an instruction requesting clothing present in the user database that is similar to the article of clothing;
receiving, from the user database, one or more identifiers for clothing present in the user database that is similar to the article of clothing.

9. The method of claim 1, further comprising:
in response to determining that the user is in possession of the article of clothing:
transmitting, to a user database, an instruction requesting the location for the article of clothing based on the identifier;
receiving, from the user database, a response indicating the location for the article of clothing;
generating for display, using the control circuitry, the location for the user based on the response from the user database.

10. The method of claim 1, further comprising:
receiving, from a user input device, an indication that the identifier for the article of clothing is incorrect and a corrected identifier for the article of clothing; and in response to receiving the indication, replacing the identifier for the article with the corrected identifier.

11. A system for acquiring an article of clothing worn by a celebrity featured in a media asset, the system comprising:
a media source including the media asset featuring the celebrity;
control circuitry configured to:
receive, from the media source, the media asset featuring the celebrity;
identify a frame in the media asset that includes the article of clothing worn by the celebrity;
determine an identifier for the article of clothing in the identified frame;
determine whether a user viewing the media asset is in possession of the article of clothing based on the identifier; and
in response to determining that the user is not in possession of the article of clothing:
determine a location for acquiring the article of clothing; and
generate for display the location for the user to acquire the article of clothing.

12. The system of claim 11, wherein the control circuitry configured to identify the frame in the media asset that includes the article of clothing worn by the celebrity comprises the control circuitry configured to:
receive, from a user input device, a first selection identifying the frame in the media asset;
receive, from the user input device, a second selection identifying the article of clothing worn by the celebrity included in the frame.

13. The system of claim 11, wherein the control circuitry configured to identify the frame in the media asset that includes the article of clothing worn by the celebrity comprises the control circuitry configured to:
receive, from the media source, metadata associated with the media asset;
extract from the metadata an indication of the frame in the media asset that includes the article of clothing;
identify the frame in the media asset and the included article of clothing worn by the celebrity based on the indication.

14. The system of claim 11, wherein the control circuitry configured to determine the identifier for the article of clothing in the identified frame comprises the control circuitry configured to:
retrieve, from a database, identifiers for a plurality of articles of clothing;
compare each article of clothing in the plurality of articles of clothing with the article of clothing in the identified frame;
identify an article of clothing in the plurality of articles of clothing with the article of clothing in the identified frame;
assign the identifier for the article of clothing in the identified frame based on the comparison.

15. The system of claim 11, wherein the control circuitry configured to determine the identifier for the article of clothing in the identified frame comprises the control circuitry configured to:
receive, from a user input device, one or more features identifying the article of clothing;
transmit, to a database, the one or more features identifying the article of clothing;
receive, from the database, a plurality of matching identifiers for the one or more features;
receive, from the user input device, a selection of the identifier for the article of clothing from the plurality of matching identifiers;
assign the selected identifier for the article of clothing in the identified frame.

16. The system of claim 11, wherein the control circuitry configured to determine whether the user viewing the media asset is in possession of the article of clothing based on the identifier comprises the control circuitry configured to:
transmit, to a user database, an instruction requesting whether the identifier for the article of clothing is present in the user database;
receive, from the user database, a response indicating whether the identifier for the article of clothing is present in the user database;
determine whether the user viewing the media asset is in possession of the article of clothing based on the response from the user database.

17. The system of claim 11, wherein the control circuitry configured to determine the location for acquiring the article of clothing comprises the control circuitry configured to:
transmit, to a location database, the identifier for the article of clothing;
receive, from the location database, a plurality of available locations for acquiring the article of clothing;
identify the location for acquiring the article of clothing from the plurality of available locations based on the user's preferences.

18. The system of claim 11, wherein the control circuitry configured to determine the location for acquiring the article of clothing comprises the control circuitry configured to:
transmit, to a user database, an instruction requesting clothing present in the user database that is similar to the article of clothing;
receive, from the user database, one or more identifiers for clothing present in the user database that is similar to the article of clothing.

19. The system of claim 11, wherein the control circuitry is further configured to:
in response to determining that the user is in possession of the article of clothing:
transmit, to a user database, an instruction requesting the location for the article of clothing based on the identifier;
receive, from the user database, a response indicating the location for the article of clothing;
generate for display, using the control circuitry, the location for the user based on the response from the user database.

20. The system of claim 11, wherein the control circuitry is further configured to:
receive, from a user input device, an indication that the identifier for the article of clothing is incorrect and a corrected identifier for the article of clothing; and
in response to receiving the indication, replace the identifier for the article with the corrected identifier.

21-50. (canceled)
